(19) United States
(12) Patent Application Publication
(10) Pub. No.: US 2019/0356038 A1
(43) Pub. Date: Nov. 21, 2019

(54) ASSEMBLIES, SYSTEMS, AND DEVICES FOR ELIMINATING POSITIONAL GAPS BETWEEN ANTENNAS LOCATED ON DIFFERENT PRINTED CIRCUIT BOARDS

(71) Applicant: GM GLOBAL TECHNOLOGY OPERATIONS LLC, Detroit, MI (US)

(72) Inventors: Amnon Jonas, Jerusalem (IL); Oded Bialer, Petah Tivak (IL)

(73) Assignee: GM GLOBAL TECHNOLOGY OPERATIONS LLC, Detroit, MI (US)

(21) Appl. No.: 15/982,584

(22) Filed: May 17, 2018

(51) Int. Cl. H01Q 1/22; H01Q 21/06

(52) U.S. Cl. CPC H01Q 1/2283; H01Q 1/3233; H01Q 21/06

(57) ABSTRACT

Assemblies, systems and devices for reducing a gap between physical antennas on multiple printed circuit boards (PCBs) are provided. The PCB assembly includes: a first PCB adjacent to a second PCB to form a mated arrangement of both PCBs wherein the first and second PCBs at least include: a first and a second set of a physical antennas positioned on the respective first and second PCBs, and at least one virtual element positioned on either PCB corresponding to one of the physical antennas; and a gap which is configured to minimize a distance between the physical antennas of the first PCB and the second PCB in the mated arrangement as well as to maintain a sufficient distance from edges of each PCB to prevent distortions resultant by an insufficient distance of the physical antennas from the edges of each PCB wherein the gap is minimized by positioning a virtual element between each set of physical antennas so the distance of the gap is determined by a lesser distance from the physical antenna to the virtual element and not a greater distance from another physical antenna.

### TECHNICAL FIELD

The technical field generally relates to antenna located on printed circuit boards (PCBs) and more specifically to methods, systems, and apparatuses for reducing radio frequency (RF) angular estimation ambiguities caused by positional gaps between RF receiver antennas located on different PCBs.

### INTRODUCTION

Multiple antenna receiver arrays provide both redundancy and improved performance of RF signal reception. This is particularly important in autonomous vehicle applications were RF signal ambiguity can affect the robustness of the received RF signals resulting in interferences of various autonomous operations. When locating the arrays of multiple RF antennas on different PCBs, it is therefore important not to influence the RF properties of each antenna particularly in the instance of high frequency reception of the RF antenna arrays.

There are several advantages in having an antenna array split and residing on different PCBs; these advantages include cheaper costs to manufacturer, flexibility of the PCBs, greater tensile strength of shorter PCBs etc. However, when placing together different PCBs to form assemblies of PCBs there is required a gap between receiver antennas when crossing different PCBs. This gap is the result of the need to maintain a minimum distance between the receiver antenna closest to the board edge and the board edge. The distance of the gap allows for at least a wavelength difference, and this required distance results in a relatively large gap produced in the full receiver antenna arrays (of all PCBs). This gap also causes angle estimation ambiguity in determining the location of the receiver antenna closest to the edge.

Accordingly, it is desirable to provide assemblies, systems and devices that enable improved antenna arrangements when arrays of multiple RF antennas are located on different PCBs by providing an interwoven arrangement of the PCBs that eliminates the array gaps while maintaining the required antenna gap from the board edge. Furthermore, other desirable features and characteristics of the present invention will become apparent from the subsequent detailed description and the appended claims, taken in conjunction with the accompanying drawings and the foregoing technical field and background.

### SUMMARY

An assembly, system and device for providing an interwoven antenna arrangement when multiple RF antennas are located on different PCBs to eliminate non-uniform gaps required from the PCB edge causing ambiguities is disclosed.

In one embodiment, a printed circuit board (PCB) assembly for minimizing a gap between physical antennas on multiple PCBs, the PCB assembly including: a first PCB adjacent to a second PCB to form a mated arrangement of both PCBs wherein the first and second PCBs at least include: a first and a second set of a physical antennas positioned on the respective first and second PCBs, and at least one virtual element positioned on either PCB corresponding to one of the physical antennas; and a gap which is configured to minimize a distance between the physical antennas of the first PCB and the second PCB in the mated arrangement as well as to maintain a sufficient distance from edges of each PCB to prevent distortions resultant by an insufficient distance of the physical antennas from the edges of each PCB wherein the gap is minimized by positioning a virtual element between each set of physical antennas so the distance of the gap is determined by a lesser distance from the physical antenna to the virtual element and not a greater distance from another physical antenna.

The PCB assembly further includes: an alignment to position the set of physical antennas in line with the virtual element in between both physical antennas of the set so all elements of both physical antennas, and the virtual element form a straight line.

The first and second PCBs are irregular shaped PCBs that are of a form factor that enables the mated arrangement to fit together. The irregular shaped PCBs are non-convex shaped PCBs.

The virtual element is positioned on either the first PCB or second PCB so the gap between a particular physical antenna and the virtual element is less than the distance of a set of particular physical antennas. The virtual element positioned on either PCB is located at an offset from the particular physical antenna of an offset distance approximately equal to the distance of an original position to a re-positioned position of the particular physical antenna. The virtual element is positioned at the offset in a position perpendicular to one of the particular physical antennas. The virtual element is positioned within a boundary of either PCB. The virtual element position is located at a distance with is the sum ptx+p1rx of an offset distance of the re-positioned physical antennas.

In yet another embodiment, a printed circuit board (PCB) system for reducing a gap between physical antennas on separate PCBs connected together is provided. The PCB system includes: a first PCB adjacent to a second PCB to form a mated arrangement of both PCBs wherein the first and second PCBs at least include: a first and a second set of a physical antennas positioned on the respective first and second PCBs, and at least one virtual element positioned on either PCB corresponding to one of the physical antennas; and a gap which is configured to minimize a distance between the physical antennas of the first PCB and the second PCB in the mated arrangement as well as to maintain a sufficient distance from edges of each PCB to prevent distortions resultant by an insufficient distance of the physical antennas from the edges of each PCB wherein the gap is minimized by positioning a virtual element between each set of physical antennas so the distance of the gap is determined by a lesser distance from the physical antenna to the virtual element and not a greater distance from another physical antenna.

The device further includes: an alignment to position the set of physical antennas in line with the virtual element in between both physical antennas of the set so all elements of both physical antennas, and the virtual element form a straight line. The first and second PCBs are irregular shaped PCBs that are of a form factor that enables the mated arrangement to fit together. The irregular shaped PCBs are non-convex shaped PCBs.

The virtual element is positioned on either the first PCB or second PCB so the gap between a particular physical antenna and the virtual element is less than the distance of a set of particular physical antennas. The virtual element positioned on either PCB is located at an offset from the particular physical antenna of an offset distance approximately equal to the distance of an original position to a re-positioned position of the particular physical antenna. The virtual element is positioned at the offset in a position perpendicular to one of the particular physical antennas. The virtual element is positioned within a boundary of either PCB. The virtual element position is located at a distance with is the sum ptx+p1rx of an offset distance of the re-positioned physical antennas.

In yet another embodiment, an antenna device for reducing a gap between physical antennas on separate printed circuit boards (PCBs) connected together is provided. The antenna device includes: a PCB adjacent to another PCB in a male-female configuration with each PCB having a physical antenna positioned thereon; a virtual element is positioned in between the physical antenna on each PCB; and a gap created by the distance between the physical antenna on each PCB wherein the gap is reduced in distance by placing the virtual element closer to the physical antenna of the first PCB so the distance of the gap is measured by the distance of the physical antenna to the virtual element which is less than the distance between each physical antenna thereby reducing the gap distance between the physical antennas while preventing distortions of edges of each PCB from physical antennas placed close to the edges.

The device, further includes: a physical antenna positioned on the second PCB at an offset from an original position equal in distance to an offset from the original position of the virtual element placement.

This summary is provided to describe select concepts in a simplified form that are further described in the Detailed Description.

This summary is not intended to identify key or essential features of the claimed subject matter, nor is it intended to be used as an aid in determining the scope of the claimed subject matter.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The exemplary embodiments will hereinafter be described in conjunction with the following drawing figures, wherein like numerals denote like elements, and wherein:

FIG. 1 is a diagram of a first and second coupled together PCB with a large gap between the transmitter and receiver antennas on each PCB in accordance with an embodiment;

FIG. 2 is a diagram of a first and second PCB coupled together with a location displacement of the transmitter and receiver antennas on the second PCB in accordance with an embodiment;

FIG. 3 is an illustration of flow control, in accordance with an embodiment;

FIG. 4 illustrates irregular shaped first and second PCBs with positioned virtual receiver antennas on the second irregular shaped PCB in accordance with an embodiment;

FIGS. 5A and 5B illustrates a convex and non-convex shape of the PCBs in accordance with an embodiment; and

FIG. 6 illustrates non-convex shaped first and second PCBs coupled together in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description.

While the features of the technology are described primarily in connection with configuring of receiver and transmitter locations on printed circuit boards (PCBs) used in radio frequency (RF) radar transmitter and receivers, the features described by the disclosure may have applicability to other types of high frequency devices using multiple PCBs and receiver/transmitter antennas including acoustic, Wi-Fi, Lidar radars etc. In addition, the described features have broad applicability for use in vehicles and in moving objects using RF radars for example to aircrafts, trucks, trailers, construction equipment, and trains etc. In addition, in particular cases, the features described may also have applicability to stationary or static objects using RF radars.

The subject matter described herein discloses assemblies, systems, devices using techniques for determining locations of a transmit and receive antenna with a sufficient gap from board edges. Typically there is found a wavelength spacing between receiver antenna and board edge.

The shortest distance between the receiver antenna and the board edges by p; that is, the shortest distance between antennas from two different boards is equal or greater than 2*μ. By locating the transmitters and receivers at particular locations on a PCB, a set of virtual array elements is obtained for the transmitters and receivers on one PCB connected to a virtual array elements of another PCB with a minimal distance that may be smaller than 2*μ without affecting edge ambiguities. The locations at shorter distances for the receiver antennas closest to the edges are obtained using non-convex PCB shapes, and a particular antenna spacing method to determine the locations on the non-convex PCBs.

In various embodiments, the present disclosure provides an apparatus and system with a reduction in the gap distance between receiver antennas on different PCBs by locating a virtual receiver antenna closer to the receiver antenna on the other PCB than a physical receiver antenna can be placed because the virtual antenna is immune to the ambiguities caused by the edges of the PCBs.

In various embodiments, the present disclosure provides an apparatus and system with a gap between the receiver antenna and the board edge in order not to distort the antenna performance; where performance is typically gain and antenna response as a function of angle and the gap can cause ambiguity in the angle estimation.

In various embodiments, the present disclosure provides assemblies, systems and devices using irregular shaped PCBs mated together to overcome the gap distances and to position the transmitter and receiver antennas linearly on at least one of the PCBs and also to position the receiver antenna closer to the other receiver antenna on the other PCB using a placement on the irregular shaped PCB configurations.

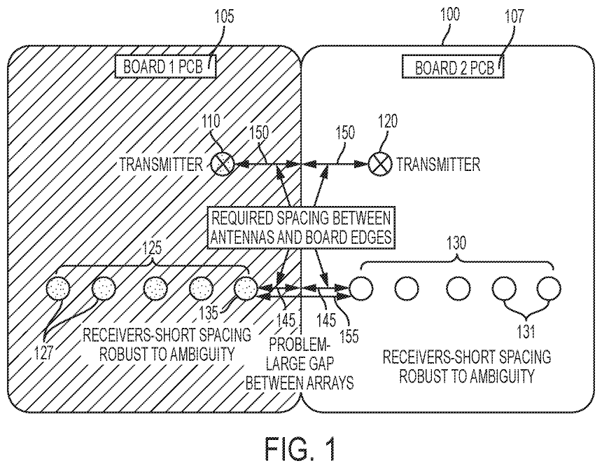

FIG. 1 is a diagram of a first and second coupled together PCB with a large gap between the transmitters and receivers on each PCB in accordance with an embodiment. In FIG. 1, there is illustrated an arrangement 100 of two PCBs coupled together. There is shown on a board 1 PCB 105 with a transmitter antenna 110 and an array of receiver antennas 125. On a board 2 PCB 107 there is shown a transmitter antenna 120 and an array of transmitter antennas 130. For a robust ambiguity to exist there needs to be a short spacing between each of the receiver antennas. This is particularly true for high RF frequencies of approximately 77 GHz. The antenna spacing 127 for each of the receiver antennas 125 on of the board 1 PCB 105 is a short spacing resulting in a robust ambiguity because the short spacing causes only a ½ wavelength difference between each of the signals received at the receiver antennas 125. Likewise, the antenna spacing 131 for each of the other receiver antennas 130 of the board 2 PCB 107 is also a short spacing resulting in a robust ambiguity because the short spacing again causes only a ½ wavelength difference between the signal received at each of the receiver antennas 125. There is also a required spacing 150 between the transmitter 110 of board 1 PCB 105 and the transmitter 120 of board 2 PCB 107 to ensure there is no ambiguity in the signals transmitted. That is, neither signal because of a greater than appropriate distance therebetween causes a distortion in the receiver antennas 130 performance and an ambiguity in the target angle estimations of signals from the transmitter 110 and the transmitter 120. Likewise, the signals from the receiver antennas 127 and the receiver antennas 130 do not have a greater than distance therebetween to cause errors or wrong estimations of the target angle estimates received by both sets of receiver antennas on each the different boards.

In instances, when the receiver antenna array or network are crossed from one PCB to another PCB; that is the location of one receiver antenna 135 is on the boards 1 PCB 105 and the location of the other receiver antenna 140 is on the board 2 PCB 107, because of the edge interference of each of the PCBs the distance 155 may be a greater than an ideal distance between both arrays of receiver antennas of each PCB. The edge interference is resulting from a distance 145 of each receiver antenna 135 and 140 to the edge of the PCBs and a particular distance used can prevent distortion in antenna performance and ambiguities resulting from the edges of the PCBs. That is, to prevent the edge ambiguity from occurring, each receiver antenna 135 and 140 must be located at a required distance 145 from the edge of the PCBs 105 and 107 so there is at least a wavelength therebetween. This required gap results in relatively large gaps in the full antenna array (i.e. lack of uniformity in the receiver antenna spacings) and the gaps cause angle estimation ambiguity.

There are advantages for splitting the PCBs into PCBs of a lesser size requiring joinder because a singular larger PCB with both sets of arrays of receiver antennas 125, 130 poses difficulties in manufacturing as well as has less tensile strength because of the additional length. That is, having a singular longer PCB with more surface area with a larger footprint to accommodate both sets of receiver antenna 125, 130 arrays results in a singular board that is less rigid and less resistant to shear stress because of the greater force resisting area caused by the larger footprint. The rigidity of the PCB is proportional to the length and width of the PCB where a longer PCB would likely experience more fatigue by virtue of its size and the stress experience which is proportional to the boundary area.

In additional, the form factor for a larger singular PCB is more cumbersome to install and more difficult to support by an under carriage for each transmitter and receiver set.

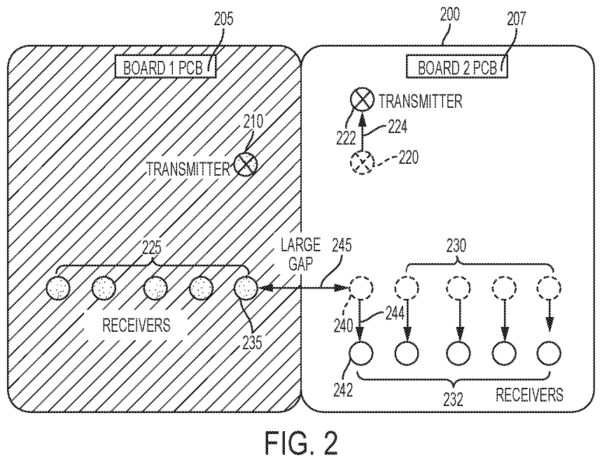

FIG. 2 is a diagram of a first and second PCB coupled together with a location displacement of the transmitter and receiver antennas on the second PCB in accordance with an embodiment. FIG. 2. Illustrates an arrangement 200 of two PCBs coupled together. There is illustrated a board 1 PCB 205 a transmitter antenna 210 and an array of receiver antennas 225. On a board 2 PCB 207 there is illustrated an original location of a transmitter antenna 220 and original locations of an array of receiver antennas 230. There exists like in FIG.1, a large gap 245 between a receiver antenna 235 on board 1 PCB 205 and an original location of the receiver antenna 240.

A displacement 224 of the original location of the transmitter antenna 220 to a new location of the transmitter antenna 222 is offset by a displacement 244 in the opposite direction of the original location of the receiver antennas 230 to the new location of the receiver antennas 242. That is, the re-positioning of the original location of the transmitter antenna 220 to the new position of the transmitter antenna 222 is counterbalanced by an equal displacement of the original location of receiver antennas 230 to a new location by a re-positioning of the receiver antennas 232. By re-positioning both the transmitter antenna 222 and the receiver antennas 232, the strength and balance of the signal transmission from the transmitter antenna 222 and the strength and balance of the signal reception from the receiver antennas 232 are unchanged. This is because the signal strength and balance is proportional to distance between the transmitter antenna 222 and the receiver antennas 242. Further, the change of location of the transmitter antenna 222 and the receiver antennas 232 does not change the balance with the corresponding transmitter antenna 210 and the receiver antennas 225. In various embodiments, each PCB (i.e. PCB 207 and PCB 205) is configured to have a physical transmitter and receiver antennas (i.e. the original transmitter antenna 222 and the original receiver antennas 232) positioned with the physical transmitter and receiver elements of each board (i.e. receiver antennas 335 and transmitter antenna 210) such that the corresponding virtual elements have smaller gap than the minimal physical gap between the receiver antennas of the two PCBs.

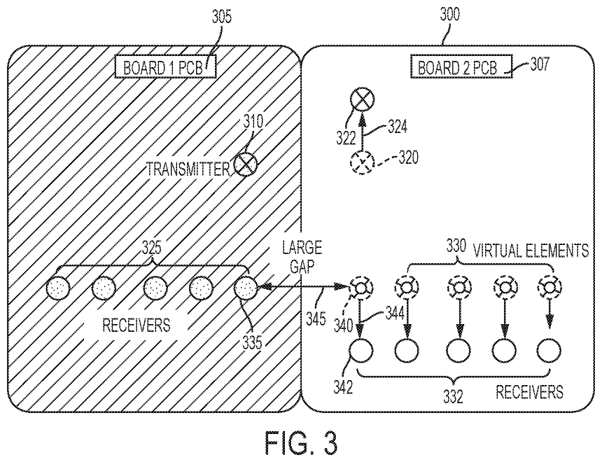

FIG. 3 is a diagram of a first and second PCB coupled together with virtual antenna elements of the transmitter and receiver antennas on the second PCB in accordance with an embodiment. In FIG. 3, the virtual receiver antennas 330 are shown in the location of the original receiver antennas (see FIG. 2). This is because the physical position of the transmitter antenna 322 has changed from the location of the original transmitter antenna 320 by a displacement of a distance 324 to the new physical location of the transmitter antenna 322. The receiver antennas 342 physical location has been moved by an equivalent opposite distance 344 which corresponds to the distance 324. The virtual positions for both the transmitter antenna 322 and the receiver antennas 332 remains the same at original locations for the transmitter antenna 320 and the receiver antennas 330.

That is, the virtual positions, because of the equal displacement of the transmitter antenna 322 and the receiver antennas 332, of the transmitter antenna 322 and the receiver antennas 332 is the original position of the transmitter antenna 320 and the receiver antennas 332. Hence, a change in location of the receiver antennas 332 still maintains the same functional equivalency when operating of the original position of by the virtual receiver antennas 330. The functional characteristics as viewed by the corresponding set of transmitter antenna 310 and receiver antennas 325 is not changed because the change in locations of the receiver antenna 332 is balanced by moving the distance between the transmitter antenna a proportional amount to the distance moved of the receiver antennas 332.

This enables a reduction in the large gap 345 between the virtual receiver antenna 340 and the receiver antenna 335 as the larger gap 345 is no longer needed because the edge interference of each of the PCBs (board 1 PCB 305 and board 2 PCB 307) no longer occurs as the receiver antenna 342 is not located at the virtual antenna 340 location and therefore not in close proximity to the edge of the Board 2 PCB 307. The transmitter antenna 310 and the receiver antennas 325 of Board 1 PCB 305 operate in the same manner and view the transmitter antenna 322 and the virtual receiver antennas 330 no differently when operating because the virtual locations of the receiver antenna elements (that correspond to each of the receiver antennas 332) are viewed as unchanged and located in the virtual locations

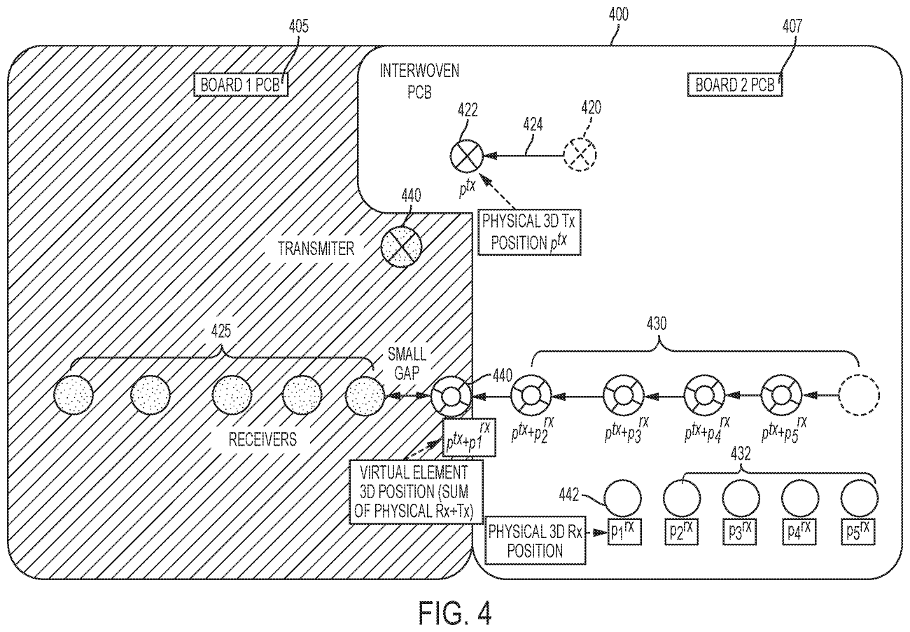

FIG. 4 illustrates irregular shaped first and second PCBs containing positioned virtual receiver antennas on the second irregular shaped PCB in accordance with an embodiment. In FIG. 4 there are two irregular shaped PCBs coupled together. It is contemplated that an irregular shape includes any shape that is not a conventional (i.e. rectangular or square like) shape of the PCBs but limited to different irregular shapes that allow for a mating or coupling together of each of the individual different irregular shaped PCBs. That is, in an exemplary embodiment, each of the irregular shaped PCBs which include the first and second PCBs may be interwoven or figuratively weaved or blended together in an adjacent manner to form a single connected structure or unit consisting of two disparate parts.

In FIG. 4 there is illustrated board 1 PCB 405 interwoven or the like with board 2 PCB 407 for the configuration 400 of the both PCBs. The virtual element 3D position is the sum of the physical receiver antenna 422 and physical receiver antenna 422. The virtual element 3D position of the virtual receiver antenna (sum of physical Rx+Tx) 440 is designated as p^{tx}+p1^{rx}. The subsequent elements are designated p^{tx}+px^{rx} where x=2 to 5. The physical 3D position of the transmitter antenna 422 is designated as p^{tx}. The physical 3D Rx position of the receiver antenna 442 is designated as p1^{rx} where the subsequent receiver antennas 432 are designated p1^{rx}. The sum of the Rx and Tx is kept a constant from the original position of the Rx and Tx but the distance between the physical Rx and Tx may be manipulated so long as the additional changes in distance from each of the elements cancel the other out. Further, the Tx and Rx must be kept in a linear line even when on different PCBs.

In an exemplary embodiment, as illustrated by FIG. 4 of the two PCBs 400 coupled together, the first PCB of Board 1 PCB 405 may be designated as a female irregular shaped design for mating together with the second Board 2 PCB 407 which is a male irregular shaped design for extending into the female irregular shaped design first PCB of Board 1 PCB 405. The transmitter antenna 422 extends in a vertical perpendicular line from the virtual receiver antenna 440. The gap between virtual receiver 440 and the transmitter receiver 435 is now a smaller gap.

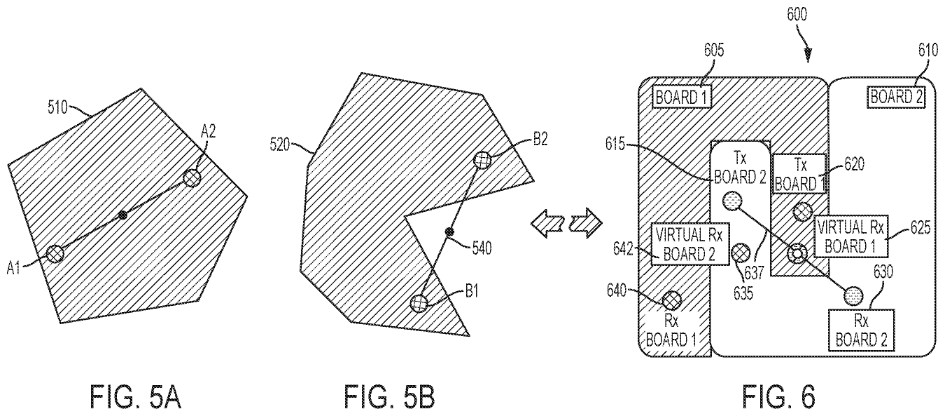

FIGS. 5A and 5B illustrates a convex and non-convex shape for the PCBs in accordance with an embodiment. In a convex shape all points on are located in a linear line that connects between two sets of points in the convex shape. In an exemplary embodiment, in FIG. 5A, in the convex shape 510, point A1 is connected to A2 in a linear line and can only intersect linearly the outer boundaries of the convex shape twice. In FIG. 5B, in a non-convex shape there are two points B1 and B2 in the non-convex shape that when linearly connect, the linear line extends beyond the boundaries of the non-convex shape 520, and further can be seen to intersect the boundaries more than twice.

In various exemplary embodiments, the PCBs are required to be formed in non-convex shapes. That is, antenna placement on a non-convex RF PCB shape is required in order to reduce receiver antenna spacing gaps between different meshed together PCBs. By the proper placement of Tx and Rx antennas on two non-convex RF board shapes, the virtual antenna elements of both boards have smaller gaps than the physical spacing between would allow because there is no longer a spacing limitation found by the PCB edge of each PCB to the receiver antenna.

In an exemplary embodiment, (in reference to FIG. 4) the first PCB of Board 1 PCB 405 may be formed as a non-convex shape 540 for interconnecting together with the second Board 2 PCB 407 which may be formed as a non-convex shape 520 design for enabling a transmitter antenna 422 of the non-convex shaped PCB to extend into a concave designated portion of the non-convex shaped designed Board 1 PCB 405.

FIG. 6 illustrates an embodiment of a convex and non-convex shape of first and second PCB coupled together in accordance with an embodiment. In FIG. 6, in an exemplary embodiment, board 1 605 in configured in an arrangement 600 together with board 2 610. The Tx 615 is located on board 2 in a linear line with the virtual Rx 625 on board 1 and the Rx 630 on board 2. The Rx 640 of board 1 is in a linear line with the virtual Rx 635 of board 2 and the Tx 620 of board 1. Both board 1 605 and board 2 610 are non-convex shapes where the midpoint of the linear segment 637 is the virtual Rx 625 and the midpoint of the linear segment 642 is the virtual Rx 635. In this instance, the two non-convex RF boards with virtual elements, have a virtual Rx element positioned at a location that is nearer to the other virtual Rx element and have a resulting shorter gap than the is found to the physical Rx elements.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A printed circuit board (PCB) assembly for minimizing a gap between physical antennas on multiple PCBs, the PCB assembly comprising:
a first PCB adjacent to a second PCB to form a mated arrangement of both PCBs wherein the first and second PCBs at least comprise: first and second sets of physical antennas positioned on the respective first and second PCBs, and at least one virtual element positioned on either PCB corresponding to one of the physical antennas wherein the virtual element is a virtual receiver or a virtual transmitter element; and
the gap which is configured to minimize a distance between the physical antennas of the first PCB and the second PCB in the mated arrangement as well as to maintain enough of a distance from edges of an opposing one of the PCBs comprising the first or second PCB in the mated arrangement in order to prevent distortions resulting by a closeness of the physical antennas from the edges of the opposing one of the PCBs wherein the gap is minimized by positioning the at least one virtual element between each set of the first and second sets of physical antennas so the distance of the gap is determined by a lesser distance from the physical antenna in each of the sets to the virtual element and not a greater distance to one of the opposing physical antenna in each of the sets of the physical antennas wherein the virtual element position is located at a distance comprising a constant sum p^{tx}+p1^{rx} of an offset distance of a re-positioned physical antennas wherein p^{tx} is the physical position of a transmitter physical antenna and p1^{rx} is a physical position of a receiver physical antenna.

2. The PCB assembly of claim 1, further comprising:
an alignment to position the set of physical antennas in line with the virtual element in between both physical antennas of the set so all elements of both physical antennas, and the virtual element form a straight line.

3. The PCB assembly of claim 2, wherein the first and second PCBs are irregular shaped PCBs that are of a form factor that enables the mated arrangement to fit together.

4. The PCB assembly of claim 3, wherein the irregular shaped PCBs are non-convex shaped PCBs.

5. The PCB assembly of claim 1, wherein the virtual element is positioned on either the first PCB or second PCB so the gap between a particular physical antenna and the virtual element is less than the distance of a set of particular physical antennas.

6. The PCB assembly of claim 5, wherein the virtual element positioned on either PCB is located at an offset from the particular physical antenna of an offset distance approximately equal to the distance of an original position to a re-positioned position of the particular physical antenna.

7. The PCB assembly of claim 6, wherein the virtual element is positioned at the offset in a position perpendicular to one of the particular physical antennas.

8. The PCB assembly of claim 7 wherein the virtual element is positioned within a boundary of either PCB.

9. (canceled)

10. A printed circuit board (PCB) system for reducing a gap between physical antennas on separate PCBs connected together, the PCB system comprising:
a first PCB adjacent to a second PCB to form a mated arrangement of both PCBs wherein the first and second PCBs at least comprise: first and second sets of physical antennas positioned on the respective first and second PCBs, and at least one virtual element positioned on either PCB corresponding to one of the physical antennas wherein the virtual element is a virtual receiver or a virtual transmitter element; and
the gap which is configured to minimize a distance between the physical antennas of the first PCB and the second PCB in the mated arrangement as well as to maintain enough of a distance from edges of an opposing one of the PCBs comprising the first or second PCB in the mated arrangement in order to prevent distortions resulting from a nearest between the physical antennas to the edges of the opposing one of the PCBs wherein the gap is minimized by positioning the at least one virtual element between each set of the first and second sets of physical antennas so the distance of the gap is determined by a lesser distance from the physical antenna in each of the sets to the virtual element and not a greater distance to one of the opposing physical antenna in each of the sets of the physical antennas wherein the virtual element position is located at a distance comprising a constant sum of p^{tx}−p1^{rx} of an offset distance of a re-positioned physical antennas wherein p^{tx} is the physical position of a transmitter physical antenna and p1^{rx} is a physical position of a receiver physical antenna.

11. The system of claim 10, further comprising:
an alignment to position the set of physical antennas in line with the virtual element in between both physical antennas of the set so all elements of both physical antennas, and the virtual element form a straight line.

12. The system of claim 11, wherein the first and second PCBs are irregular shaped PCBs that are of a form factor that enables the mated arrangement to fit together.

13. The system of claim 12, wherein the irregular shaped PCBs are non-convex shaped PCBs.

14. The system of claim 13, wherein the virtual element is positioned on either the first PCB or second PCB so the gap between a particular physical antenna and the virtual element is less than the distance of a set of particular physical antennas.

15. The system of claim 14, wherein the virtual element positioned on either PCB is located at an offset from the particular physical antenna of an offset distance approximately equal to the distance of an original position to a re-positioned position of the particular physical antenna.

16. The system of claim 15, wherein the virtual element is positioned at the offset in a position perpendicular to one of the particular physical antennas.

17. The system of claim 16 wherein the virtual element is positioned within a boundary of either PCB.

18. (canceled)

19. An antenna device for reducing a gap between physical antennas on separate printed circuit boards (PCBs) connected together, said antenna device comprising:
a PCB adjacent to another PCB comprising a set of PCBs of a first PCB and a second PCB in a male-female configuration with each one of the PCBs having a physical antenna positioned thereon;
a virtual element is positioned in between the physical antenna on each PCB;
a gap created by the distance between the physical antenna on each one of the PCBs in the set of PCBs wherein the gap is reduced in distance by placing the virtual element closer to the physical antenna of the first PCB so the distance of the gap is measured by the distance of the physical antenna to the virtual element which is less than the distance between each one of the physical antennas on the first and second PCBs thereby reducing the gap distance between the physical antennas by a placement of while preventing distortions of edges of each PCB from physical antennas placed close to the edges; and
an alignment to position the set of physical antennas in line with the virtual element in between both physical antennas of the set so all elements of both physical antennas, and the virtual element form a straight line wherein the first and second PCBs are irregular shaped PCBs that are of a form factor that enables the mated arrangement to fit together wherein the irregular shaped PCBs are non-convex shaped PCBs wherein the virtual element is positioned on either the first PCB or second PCB so the gap between a particular physical antenna and the virtual element is reduced in distance between a set of particular physical antennas wherein the virtual element positioned on either PCB is located at an offset from the particular physical antenna of an offset distance approximately equal to the distance of an original position to a re-positioned position of the particular physical antenna wherein the virtual element is positioned at the offset in a position perpendicular to one of the particular physical antennas wherein the virtual element is positioned within a boundary of either PCB wherein the virtual element position is located at a distance comprising a constant sum p^{tx}+p1^{rx} of an offset distance of the re-positioned physical antennas wherein p^{tx} is the physical position of a transmitter physical antenna and p1^{rx} is a physical position of a receiver physical antenna.

20. The device of claim 19, further comprising:
the physical antenna positioned on the second PCB at an offset from an original position equal in distance to an offset from the original position of the virtual element placement.
